(19) United States
(12) Patent Application Publication
(10) Pub. No.: US 2021/0342549 A1
(43) Pub. Date: Nov. 4, 2021

(54) METHOD FOR TRAINING SEMANTIC ANALYSIS MODEL, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Jiaxiang Liu, Beijing (CN); Shikun Feng, Beijing (CN)

(73) Assignee: BEIJING BAIDU NETCOM SCIENCE AND TECHNOLOGY CO., LTD., Beijing (CN)

(21) Appl. No.: 17/375,156

(22) Filed: Jul. 14, 2021

(30) Foreign Application Priority Data
Dec. 9, 2020 (CN) 202011451655.2

(51) Int. Cl. G06F 40/30; G06F 40/58; G06N 20/00; G06F 16/901

(52) U.S. Cl. CPC G06F 40/30; G06F 16/9024; G06N 20/00; G06F 40/58

(57) ABSTRACT

The disclosure provides a method for training a semantic analysis model, an electronic device and a storage medium. The method includes: obtaining a plurality of training data, in which each of the plurality of training data comprises a search word, information on at least one text obtained by searching the search word, and at least one associated word corresponding to the at least one text; constructing a graph model based on the training data, and determining target training data from the plurality of training data by using the graph model, the target training data comprising search word samples, information samples and associated word samples; and training a semantic analysis model based on the search word samples, the information samples, and the associated word samples.

### CROSS-REFERENCE TO RELATED APPLICATION

The present application is based upon and claims priority to Chinese Patent Application No. 202011451655.2, filed on Dec. 9, 2020, the entirety contents of which are incorporated herein by reference.

### TECHNICAL FIELD

The disclosure relates to a field of computer technologies, specifically to fields of artificial intelligence technologies such as natural language processing, deep learning and big data processing, and in particular to a method for training a semantic analysis model, an electronic device and a storage medium.

### BACKGROUND

Artificial intelligence (AI) is a study of using computers to simulate certain human thinking processes and intelligent behaviors (such as learning, reasoning, thinking and planning), which has both hardware-level technologies and software-level technologies. AI hardware technologies generally include technologies such as sensors, dedicated AI chips, cloud computing, distributed storage and big data processing. AI software technologies mainly include computer vision technologies, speech recognition technologies, natural language processing technologies, machine learning/depth learning, big data processing technologies and knowledge graph technologies.

In the related arts, big data is generally used to construct unsupervised tasks for pre-training of a semantic analysis model.

### SUMMARY

The embodiments of the disclosure provide a method for training a semantic analysis model, an electronic device, and a storage medium.

Embodiments of the disclosure provide a method for training a semantic analysis model. The method includes: obtaining a plurality of training data, in which each of the plurality of training data comprises a search word, information on at least one text obtained by searching the search word, and at least one associated word corresponding to the at least one text; constructing a graph model based on the training data, and determining target training data from the plurality of training data by using the graph model, the target training data comprising search word samples, information samples and associated word samples; and training a semantic analysis model based on the search word samples, the information samples, and the associated word samples.

Embodiments of the disclosure provide an electronic device. The electronic device includes: at least one processor and a memory communicatively coupled to the at least one processor. The memory stores instructions executable by the at least one processor. When the instructions are implemented by the at least one processor, the at least one processor is caused to implement a method for training a semantic analysis model. The method includes: obtaining a plurality of training data, in which each of the plurality of training data comprises a search word, information on at least one text obtained by searching the search word, and at least one associated word corresponding to the at least one text; constructing a graph model based on the training data, and determining target training data from the plurality of training data by using the graph model, the target training data comprising search word samples, information samples and associated word samples; and training a semantic analysis model based on the search word samples, the information samples, and the associated word samples.

Embodiments of the disclosure provide a non-transitory computer-readable storage medium storing computer instructions. The computer instructions are used to make the computer implement a method for training a semantic analysis model. The method includes: obtaining a plurality of training data, in which each of the plurality of training data comprises a search word, information on at least one text obtained by searching the search word, and at least one associated word corresponding to the at least one text; constructing a graph model based on the training data, and determining target training data from the plurality of training data by using the graph model, the target training data comprising search word samples, information samples and associated word samples; and training a semantic analysis model based on the search word samples, the information samples, and the associated word samples.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram of the first embodiment of the disclosure.

FIG. 2 is a schematic diagram of a graph model according to embodiments of the disclosure.

FIG. 3 is a schematic diagram of the second embodiment of the disclosure.

FIG. 4 is a schematic diagram of the third embodiment of the disclosure.

FIG. 5 is a schematic diagram of the fourth embodiment of the disclosure.

FIG. 6 is a block diagram of an electronic device used to implement the method for training a semantic analysis model of embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

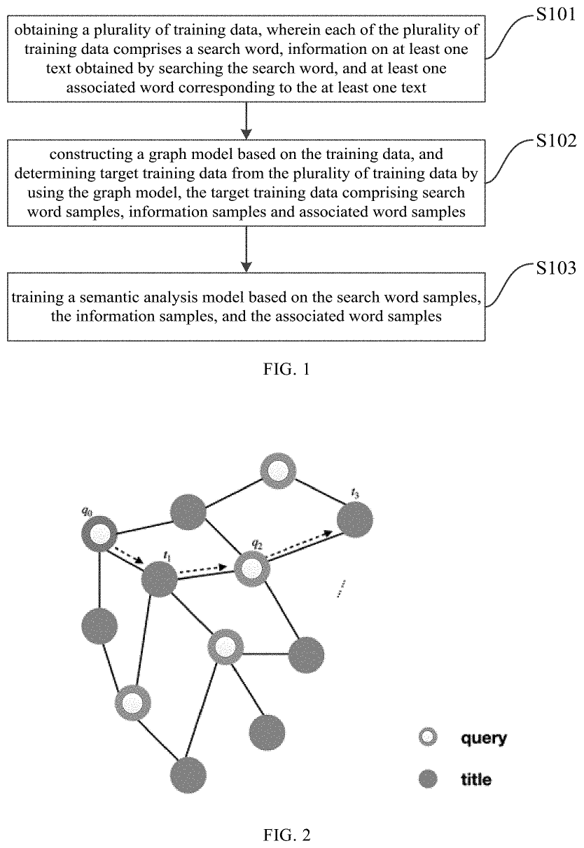

FIG. 1 is a schematic diagram of the first embodiment of the disclosure.

It should be noted that the execution subject of the method for training the semantic analysis model of the embodiment is an apparatus for training the semantic analysis model, which may be implemented by software and/or hardware. The apparatus may be configured in an electronic device, and the electronic device may include but are not limited to a terminal and a server.

The embodiments of the disclosure relate to a field of artificial intelligence technologies such as natural language processing, deep learning and big data processing.

AI is a new technological science that studies and develops theories, methods, technologies and application systems used to simulate, extend and expand human intelligence.

Deep learning is to learn inherent laws and representation levels of sample data. The information obtained in the learning process is of great help to interpretation of data such as text, images and sounds. The ultimate goal of deep learning is to allow machines to have the ability to analyze and learn like humans, and to recognize data such as text, images and sounds.

Natural language processing realizes various theories and methods for effective communication between humans and computers in natural language. Deep learning is to learn the internal laws and representation levels of sample data. The information obtained in the learning process is of great help to the interpretation of data such as text, images and sounds. The ultimate goal of deep learning is to allow machines to have the ability to analyze and learn like humans, and to recognize data such as text, images and sounds.

Big data processing refers to the process of using AI to analyze and process huge-scale data. Big data may be represented as 5V, i.e., large data volume (Volume), fast speed (Velocity), Many types (Variety), Value and Veracity.

As illustrated in FIG. 1, the method for training a semantic analysis model includes the following steps.

A step S101, a plurality of training data is obtained, each of the plurality of training data includes a search word, information on at least one text obtained by searching the search word, and at least one associated word corresponding to the at least one text.

In an embodiment, a large amount of training data may be obtained in advance with the assistance of a search engine. Training data such as search terms commonly used by users, text searched by the search engine using the search terms, text information (information such as text title or abstract, or text Hyperlinks, which is not limited), and other search terms associated with the at least one text (other search terms associated with the at least one text is called associated words corresponding to the at least one text).

In the embodiments of the disclosure, after obtaining a plurality of training data with the assistance of the search engine in advance, the plurality of training data is obtained, each of the plurality of training data includes a search word, information on at least one text obtained by searching the search word, and at least one associated word corresponding to the at least one text, which is not limited in the disclosure.

A step S102, a graph model is constructed based on the training data, and target training data is determined from the plurality of training data by using the graph model, the target training data includes search word samples, information samples and associated word samples.

One or more sets of training data that are more suitable for the semantic analysis model determined from the multiple sets of training data according to the graph model can be called target training data, that is, the number of sets of target training data It can be one group or multiple groups, and there is no restriction on this.

After obtaining multiple sets of training data, the graph model is constructed based on the training data, and the target training data is determined from the training data according to the graph model. The training data more suitable for the semantic analysis model is determined from the plurality of training data according to the graph model, which may be called the target training data. That is, the determined target training data may be divided into one or more group, which is not limited herein.

After obtaining the training data, the training data may be used to construct the graph model, and the target training data may be determined from the training data according to the graph model, so that the training data more suitable for the semantic analysis model is rapidly determined, which improves efficiency of model training and ensures effect of model training.

The graph model may be a graph model in deep learning, or may also be a graph model in any other possible architectural form in the field of artificial intelligence technologies, which is not limited here.

The graphical model in the embodiments of the disclosure is a graphical representation of probability distribution. A graph is composed of nodes and links among the nodes. In a probability graphical model, each node represents a random variable (or a group of random variables). The link represents a probability relation between these variables. In this way, the graphical model describes the way that joint probability distribution is decomposed into a set of factor products on all random variables, and each factor only depends on a subset of the random variables.

Optionally, in some embodiments, the target graph model includes: a plurality of paths, each path connects a plurality of nodes, and each node corresponds to one search word or one associated word or one piece of the information, and the path describes a searching correlation weight among corresponding contents of the nodes connected by the path. Therefore, the distribution of search correlation weights in the plurality of groups of training data are clearly and efficiently presented, and the training data in search application scenarios is integrated with semantic analysis models.

That is, in the embodiments of the disclosure, the graph model is constructed based on the plurality of the training data, and the target training data may be determined from the plurality of the training data according to the graph model. The target training data includes: search word samples, information samples and associated word samples. Thus, the subsequent use of the determined search word samples, information samples and associated word samples is triggered to train the semantic analysis model, so that the semantic analysis model could better learn a contextual semantic relation between the training data in the search application scenario.

Optionally, in some embodiments, the graph model is constructed based on the plurality of the training data, and the target training data is determined from the plurality of the training data according to the graph model, so that the search word, search information, and a search correction weight in the training data may be obtained. The initial graph model is constructed based on the training data, and iteratively train the initial graph model according to the search correlation weight to obtain the target graph model. The target training data is determined from the plurality of the training data according to the target graph model, which effectively improves the training effect of the graph model, and makes the target graph model obtained by training have better screening ability on the target training data.

For example, the search correlation weight may be preset. For example, if the search term is A, text A1 and text A2 obtained in the search application scenario are determined based on the search term A, then the search correlation weight of text A1 is 1, and the search correlation weight of text A2 is 2, and the associated word 1 corresponding to text A1, the search correlation weight between text A1 and the associated word 1 may be 11. Assuming that a path connects the search term A and the text A1, the search correlation weight of the path is 1. Assuming that a path connects the search term A and the text A2, the search correlation weight of the path is 2, and assuming a path connects the text A1 and the associated word 1, then the search correlation weight described by the path is 11.

FIG. 2 is a schematic diagram of a graph model according to embodiments of the disclosure. In FIG. 2, q0 represents a search term, t1 represents the information text (the text may be specifically clicked on) searched by the search term q0, q2 represents the associated word corresponding to the text t1, t3 represents the text searched by the associated word q2, and the process is continued until an initial graph model is constructed. The initial graph model may be iteratively trained according to the search correlation weight to obtain the target graph model. The target training data may be determined from the training data according to the target graph model.

For example, after the initial graph model is constructed as described above, a loss value may be calculated according to the search correlation weight described by each path included in the initial graph model, and the initial graph model may be iteratively trained according to the loss value, until the loss value output by the initial graph model satisfies the preset value, the graph model obtained by training is used as the target graph model, which is not limited.

Then, the target graph model is used to assist in determining the target training data, which is determined with reference to the following embodiments.

At step S103, a semantic analysis model is trained based on the search word samples, the information samples, and the associated word samples.

After constructing the graph model using the training data, and the target training data is determined from the training data according to the graph model, the semantic analysis model is trained based on the search word samples, the information samples, and the associated word samples in the target training data.

The semantic analysis model in the embodiments of the disclosure is a Bidirectional Encoder Representation from Transformer (BERT) model based on machine translation, or may be any other possible neural network models in the field of artificial intelligence, which is not limited herein.

When the search word samples, the information samples, and the associated word samples are used to train the BERT model based on machine translation, the trained BERT model may have better semantic analysis capabilities, and the BERT model is usually applied to other pre-training tasks in model training, which effectively improves the model performance of pre-training tasks based on the BERT model in the search application scenarios.

In the embodiment, by constructing the training data into the graph model, the graph model is used to determine the target training data, and the target training data includes search word samples, information samples and associated word samples. The search word samples enable the semantic analysis model obtained by training to be effectively applied to the training data in the search application scenario, thereby improving the performance effect of the semantic analysis model in the search application scenario.

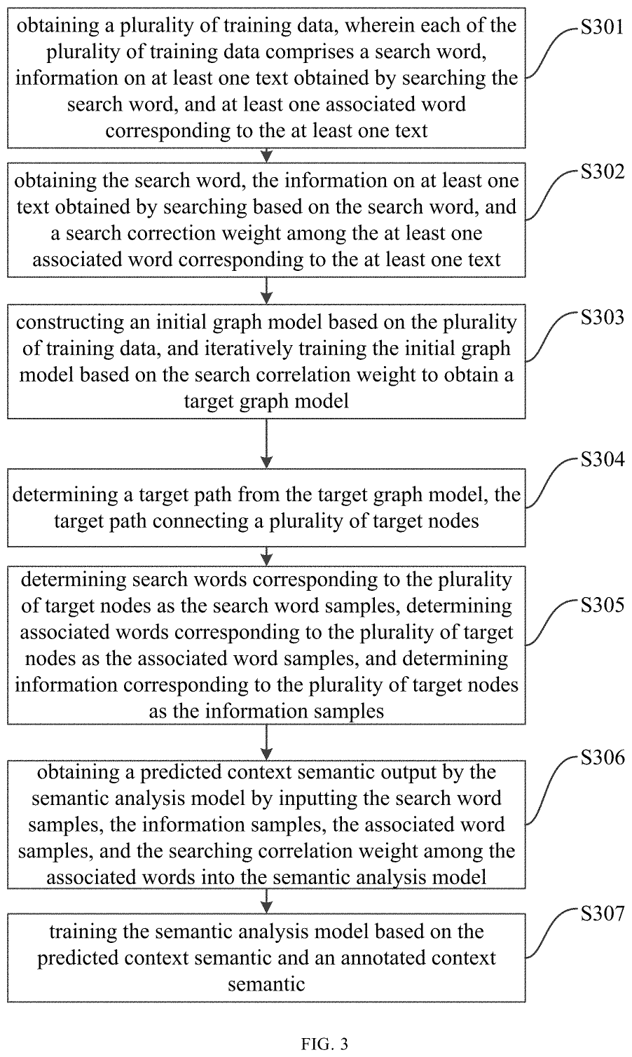

FIG. 3 is a schematic diagram of the second embodiment of the disclosure.

As illustrated in FIG. 3, the method for training a semantic analysis model includes the following steps.

At step S301, a plurality of training data is obtained, each of the plurality of training data includes a search word, information on at least one text obtained by searching the search word, and at least one associated word corresponding to the at least one text.

At step S302, the search word, the information on at least one text obtained by searching based on the search word, and a search correction weight among the at least one associated word corresponding to the at least one text may be obtained.

At step S303, an initial graph model is constructed based on the plurality of training data, and the initial graph model is iteratively trained based on the search correlation weight to obtain a target graph model.

For the description of steps S301-S303, refer to the above embodiments, which is not repeated here.

At step S304, a target path is determined from the target graph model, the target path connecting a plurality of target nodes.

Optionally, in some embodiments, determining the target path from the target graph model includes: determining the target path from the target graph model based on a random walking mode; or determining the target path from the target graph model based on a breadth-first searching mode.

For example, in combination with the graph model structure presented in FIG. 2, when a random walking mode is adopted to determine the target path from the target graph model, the obtained training data on the target path may be expressed as S=[q0, t1, . . . , QN−1, tN]. When the breadth-first searching mode is used to determine the target path from the target graph model, the training data on the target path may be expressed as S=[q0, t1, . . . , tN].

Certainly, any other possible selection methods may be used to determine the target path from the target graph model, such as a modeling mode and an engineering mode, which is not limited.

At step S305, search words corresponding to the plurality of target nodes are determined as the search word samples, associated words corresponding to the plurality of target nodes are determined as the associated word samples, and information corresponding to the plurality of target nodes is determined as the information samples.

In the above random walking mode, the target path is determined from the target graph model by using the random walking mode, or the target path is determined from the target graph model based on a breadth-first searching mode. The target path connects a plurality of target nodes. Search words corresponding to the plurality of target nodes are determined as the search word samples, associated words corresponding to the plurality of target nodes are determined as the associated word samples, and information corresponding to the plurality of target nodes is determined as the information samples. When the semantic analysis model obtained by training is effectively applied to the training data in search application scenarios, completeness of model data obtaining may be improved, the efficiency of model data obtaining may be improved, and time cost of overall model training may be effectively reduced.

At step S306, a predicted context semantic output by the semantic analysis model is obtained by inputting the search word samples, the information samples, the associated word samples, and the searching correlation weight among the associated words into the semantic analysis model.

At step S307, the semantic analysis model is trained based on the predicted context semantic and an annotated context semantic.

In the above example, since the target training data is determined, each of the plurality of training data includes a search word, information on at least one text obtained by searching the search word, and at least one associated word corresponding to the at least one text. The sum of the search correlation weights on the target path corresponding to each of the plurality of training data may be used as the search correlation weight between the search word samples, information samples and associated word samples.

Thus, based on the search word samples, the information samples and the associated word samples, a predicted context semantic output by the BERT model is obtained by inputting the search word samples, the information samples and the searching correlation weight among the associated words into the BERT model based on machine translation, to obtain the predicted context semantic output by the BERT model. A loss value between the predicted context semantic and the annotated context semantic is determined, and training of the semantic analysis model is completed in response to the loss value meeting a reference loss value, to improve training efficiency and accuracy of the semantic analysis model.

For example, a corresponding loss function may be configured for the BERT model based on machine translation, and based on the loss function, after calculating the sample search terms, sample information, sample associated words and search correlation weights, the loss value between the predicted context semantic and the labeled context semantic is obtained, so that the loss value is compared with a pre-calibrated reference loss value, if the loss value meets the reference loss value, the semantic analysis model training is completed.

The trained semantic analysis model is configured to perform semantic analysis on a segment of input text to determine hidden words in the piece of text, or, to analyze whether the segment of text comes from a specific text, which is not limited herein.

In an embodiment, the training data is constructed into the graph model, and the graph model is configured to determine the target training data, and the target training data includes search word samples, information samples and associated word samples. The semantic analysis model obtained by training may be effectively applied to the training data in the search application scenario, and the performance effect of the semantic analysis model in the search application scenario is improved. When the semantic analysis model obtained by training may be effectively applied to the training data in search application scenarios, the completeness of obtaining model data may be improved, the efficiency of obtaining model data may be improved, and time cost of overall model training may be effectively reduced. By inputting the search word samples, the information samples, the associated word samples, and the searching correlation weight into the semantic analysis model, a predicted context semantic output by the semantic analysis model is obtained. The semantic analysis model is trained according to the predicted context semantic and the annotated context semantic, which effectively improves the training effect of the semantic analysis model, and further guarantees the applicability of the semantic analysis model in the search application scenario.

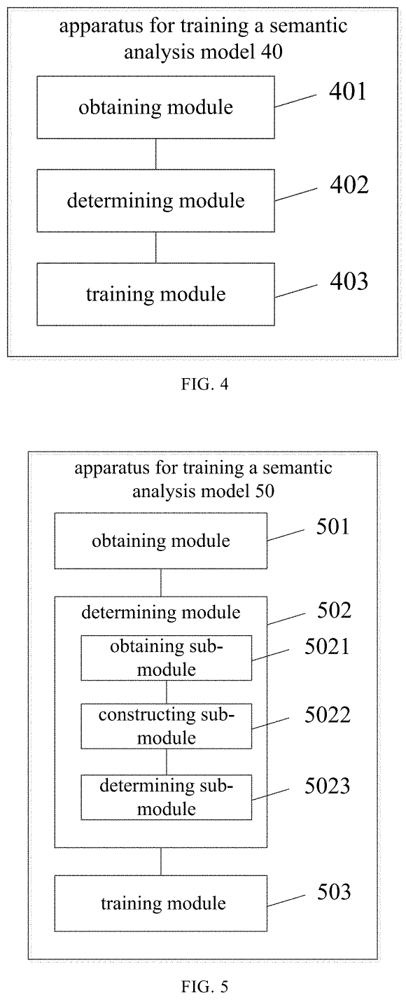

FIG. 4 is a schematic diagram of the third embodiment of the disclosure.

As illustrated in FIG. 4, the apparatus for training a semantic analysis model 40 includes: an obtaining module 401, a determining module 402 and a training module 403. The obtaining module 401 is configured to obtain a plurality of training data, in which each of the plurality of training data includes a search word, information on at least one text obtained by searching the search word, and at least one associated word corresponding to the at least one text. The determining module 402 is configured to construct a graph model based on the training data, and determine target training data from the plurality of training data by using the graph model, the target training data includes search word samples, information samples and associated word samples. The training module 403 is configured to train a semantic analysis model based on the search word samples, the information samples, and the associated word samples.

In some embodiments, FIG. 5 is a schematic diagram of the fourth embodiment of the disclosure. As illustrated in FIG. 5, the apparatus for training a semantic analysis model 50 includes: an obtaining module 501, a determining module 502 and a training module 503. The determining module 502 includes: an obtaining sub-module 5021, a constructing sub-module 5022 and a determining sub-module 5023. The obtaining sub-module 5021 is configured to obtain the search word, the information on at least one text obtained by searching based on the search word, and a search correction weight among the at least one associated word corresponding to the at least one text. The constructing sub-module 5022 is configured to construct an initial graph model based on the plurality of training data, and to iteratively train the initial graph model based on the search correlation weight to obtain a target graph model. The determining sub-module 5023 is configured to determine the target training data from the plurality of training data by using the target graph model.

In some embodiments, the target graph model includes a plurality of paths, each path connects a plurality of nodes, and each node corresponds to one search word or one associated word or one piece of the information, and the path describes a searching correlation weight among corresponding contents of the nodes connected by the path.

In some embodiments, the determining sub-module 5023 is further configured to: determine a target path from the target graph model, the target path connecting a plurality of target nodes; and determine search words corresponding to the plurality of target nodes as the search word samples, determine associated words corresponding to the plurality of target nodes as the associated word samples, and determine information corresponding to the plurality of target nodes as the information samples.

In some embodiments, the determining sub-module 5023 is further configured to: determine the target path from the target graph model based on a random walking mode; or determine the target path from the target graph model based on a breadth-first searching mode.

In some embodiments, the training module 503 is further configured to: obtain a predicted context semantic output by the semantic analysis model by inputting the search word samples, the information samples, the associated word samples, and the searching correlation weight among the associated words into the semantic analysis model; and train the semantic analysis model based on the predicted context semantic and an annotated context semantic.

In some embodiments, the training module 503 is further configured to: determine a loss value between the predicted context semantic and the annotated context semantic; and determine that training of the semantic analysis model is completed in response to the loss value meeting a reference loss value.

In some embodiments, the semantic analysis model is a Bidirectional Encoder Representation from Transformer (BERT) based on machine translation.

It is understandable that the apparatus for training the semantic analysis model 50 in FIG. 5 of the embodiment and the apparatus for training the semantic analysis model 40 in the above embodiments, the obtaining module 501 and the obtaining module 401 in the above embodiments, the determining module 502 and the determining module 402 in the above embodiments, and the training module 503 and the training module 403 in the above embodiments, may have the same function and structure.

It should be noted that the foregoing explanation of the method for training the semantic analysis model is also applicable to the apparatus for training the semantic analysis model of the embodiment, which is not repeated here.

In the embodiment, the graph model is constructed based on the training data, and the graph model is used to determine the target training data. The target training data includes search word samples, information samples and associated word samples. The semantic analysis model obtained by training is effectively applied to the training data in the search application scenario, and the performance effect of the semantic analysis model in the search application scenario is improved.

According to the embodiments of the disclosure, the disclosure also provides an electronic device, a readable storage medium and a computer program product.

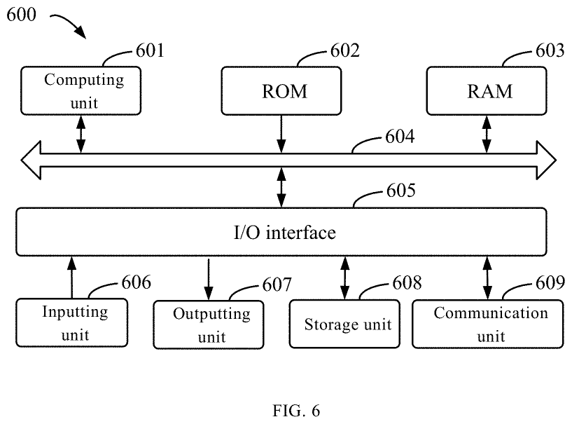

FIG. 6 is a block diagram of an electronic device configured to implement the method for training a semantic analysis model according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the device 600 includes a computing unit 601 performing various appropriate actions and processes based on computer programs stored in a read-only memory (ROM) 602 or computer programs loaded from the storage unit 608 to a random access memory (RAM) 603. In the RAM 603, various programs and data required for the operation of the device 600 are stored. The computing unit 601, the ROM 602, and the RAM 603 are connected to each other through a bus 604. An input/output (I/O) interface 605 is also connected to the bus 604.

Components in the device 900 are connected to the I/O interface 605, including: an inputting unit 606, such as a keyboard, a mouse; an outputting unit 607, such as various types of displays, speakers; a storage unit 608, such as a disk, an optical disk; and a communication unit 609, such as network cards, modems, wireless communication transceivers, and the like. The communication unit 609 allows the device 600 to exchange information/data with other devices through a computer network such as the Internet and/or various telecommunication networks.

The computing unit 601 may be various general-purpose and/or dedicated processing components with processing and computing capabilities. Some examples of computing unit 601 include, but are not limited to, a central processing unit (CPU), a graphics processing unit (GPU), various dedicated artificial intelligence (AI) computing chips, various computing units that run machine learning model algorithms, and a digital signal processor (DSP), and any appropriate processor, controller and microcontroller. The computing unit 601 executes the various methods and processes described above, for example, a method for training a semantic analysis model.

For example, in some embodiments, the method for training the semantic analysis model may be implemented as a computer software program, which is tangibly contained in a machine-readable medium, such as the storage unit 608. In some embodiments, part or all of the computer program may be loaded and/or installed on the device 600 via the ROM 602 and/or the communication unit 609. When the computer program is loaded on the RAM 603 and executed by the computing unit 601, one or more steps of the method for training the semantic analysis model described above may be executed. Alternatively, in other embodiments, the computing unit 601 may be configured to perform the method for training the semantic analysis model in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method for training the semantic analysis model of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a blockchain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for training a semantic analysis model, comprising:
obtaining a plurality of training data, wherein each of the plurality of training data comprises a search word, information on at least one text obtained by searching the search word, and at least one associated word corresponding to the at least one text;
constructing a graph model based on the training data, and determining target training data from the plurality of training data by using the graph model, the target training data comprising search word samples, information samples and associated word samples; and
training a semantic analysis model based on the search word samples, the information samples, and the associated word samples.

2. The method according to claim 1, wherein constructing the graph model based on the training data, and determining the target training data from the plurality of training data by using the graph model, comprises:
obtaining the search word, the information on at least one text obtained by searching based on the search word, and a search correction weight among the at least one associated word corresponding to the at least one text;
constructing an initial graph model based on the plurality of training data, and iteratively training the initial graph model based on the search correlation weight to obtain a target graph model; and
determining the target training data from the plurality of training data by using the target graph model.

3. The method according to claim 2, wherein the target graph model comprises a plurality of paths, each path connects a plurality of nodes, and each node corresponds to one search word or one associated word or one piece of the information, and the path describes a searching correlation weight among corresponding contents of the nodes connected by the path.

4. The method according to claim 3, wherein determining the target training data from the plurality of training data by using the target graph model comprises:
determining a target path from the target graph model, the target path connecting a plurality of target nodes; and
determining search words corresponding to the plurality of target nodes as the search word samples, determining associated words corresponding to the plurality of target nodes as the associated word samples, and determining information corresponding to the plurality of target nodes as the information samples.

5. The method according to claim 4, wherein determining the target path from the target graph model comprises:
determining the target path from the target graph model based on a random walking mode; or
determining the target path from the target graph model based on a breadth-first searching mode.

6. The method according to claim 2, wherein training the semantic analysis model based on the search word samples, the information samples, and the associated word samples comprises:
obtaining a predicted context semantic output by the semantic analysis model by inputting the search word samples, the information samples, the associated word samples, and the searching correlation weight among the associated words into the semantic analysis model; and
training the semantic analysis model based on the predicted context semantic and an annotated context semantic.

7. The method according to claim 6, wherein training the semantic analysis model based on the predicted context semantic and the annotated context semantic comprises:
determining a loss value between the predicted context semantic and the annotated context semantic; and
determining that training of the semantic analysis model is completed in response to the loss value meeting a reference loss value.

8. The method according to claim 1, wherein the semantic analysis model is a Bidirectional Encoder Representation from Transformer (BERT) based on machine translation.

9. An electronic device, comprising:
at least one processor; and
a memory communicatively connected with the at least one processor; wherein,
the memory stores instructions executable by the at least one processor, and when the instructions are executed by the at least one processor, the at least one processor is caused to:
obtain a plurality of training data, wherein each of the plurality of training data comprises a search word, information on at least one text obtained by searching the search word, and at least one associated word corresponding to the at least one text;
construct a graph model based on the training data, and determining target training data from the plurality of training data by using the graph model, the target training data comprising se arch word samples, information samples and associated word samples; and
train a semantic analysis model based on the search word samples, the information samples, and the associated word samples.

10. The electronic device according to claim 9, wherein the at least one processor is configured to:
obtaining the search word, the information on at least one text obtained by searching based on the search word, and a search correction weight among the at least one associated word corresponding to the at least one text;
constructing an initial graph model based on the plurality of training data, and iteratively training the initial graph model based on the search correlation weight to obtain a target graph model; and
determining the target training data from the plurality of training data by using the target graph model.

11. The electronic device according to claim 10, wherein the target graph model comprises a plurality of paths, each path connects a plurality of nodes, and each node corresponds to one search word or one associated word or one piece of the information, and the path describes a searching correlation weight among corresponding contents of the nodes connected by the path.

12. The electronic device according to claim 11, wherein the at least one processor is configured to:
determine a target path from the target graph model, the target path connecting a plurality of target nodes; and
determine search words corresponding to the plurality of target nodes as the search word samples, determine associated words corresponding to the plurality of target nodes as the associated word samples, and determine information corresponding to the plurality of target nodes as the information samples.

13. The electronic device according to claim 12, wherein the at least one processor is configured to:
determining the target path from the target graph model based on a random walking mode; or
determining the target path from the target graph model based on a breadth-first searching mode.

14. The electronic device according to claim 10, wherein the at least one processor is configured to:
obtain a predicted context semantic output by the semantic analysis model by inputting the search word samples, the information samples, the associated word samples, and the searching correlation weight among the associated words into the semantic analysis model; and
train the semantic analysis model based on the predicted context semantic and an annotated context semantic.

15. The electronic device according to claim 14, wherein the at least one processor is configured to:
determine a loss value between the predicted context semantic and the annotated context semantic; and
determine that training of the semantic analysis model is completed in response to the loss value meeting a reference loss value.

16. The electronic device according to claim 9, wherein the semantic analysis model is a Bidirectional Encoder Representation from Transformer (BERT) based on machine translation.

17. A non-transitory computer-readable storage medium storing computer instructions, wherein the computer instructions are configured to make the computer execute a method for training a semantic analysis model, and the method comprises:
obtaining a plurality of training data, wherein each of the plurality of training data comprises a search word, information on at least one text obtained by searching the search word, and at least one associated word corresponding to the at least one text;
constructing a graph model based on the training data, and determining target training data from the plurality of training data by using the graph model, the target training data comprising search word samples, information samples and associated word samples; and
training a semantic analysis model based on the search word samples, the information samples, and the associated word samples.

18. The non-transitory computer-readable storage medium according to claim 17, wherein constructing the graph model based on the training data, and determining the target training data from the plurality of training data by using the graph model, comprises:
obtaining the search word, the information on at least one text obtained by searching based on the search word, and a search correction weight among the at least one associated word corresponding to the at least one text;
constructing an initial graph model based on the plurality of training data, and iteratively training the initial graph model based on the search correlation weight to obtain a target graph model; and
determining the target training data from the plurality of training data by using the target graph model.

19. The non-transitory computer-readable storage medium according to claim 18, wherein the target graph model comprises a plurality of paths, each path connects a plurality of nodes, and each node corresponds to one search word or one associated word or one piece of the information, and the path describes a searching correlation weight among corresponding contents of the nodes connected by the path.

20. The non-transitory computer-readable storage medium according to claim 19, wherein determining the target training data from the plurality of training data by using the target graph model comprises:
determining a target path from the target graph model, the target path connecting a plurality of target nodes; and
determining search words corresponding to the plurality of target nodes as the search word samples, determining associated words corresponding to the plurality of target nodes as the associated word samples, and determining information corresponding to the plurality of target nodes as the information samples.
